(19) United States
(12) Patent Application Publication
(10) Pub. No.: US 2025/0019498 A1
(43) Pub. Date: Jan. 16, 2025

(54) PROCESS FOR PREPARING BRANCHED ORGANOPOLYSILOXANES

(71) Applicant: WACKER CHEMIE AG, Munich (DE)

(72) Inventor: Marko PRASSE, Glaubitz (DE)

(73) Assignee: WACKER CHEMIE AG, Munich (DE)

(21) Appl. No.: 18/715,775

(22) PCT Filed: Dec. 3, 2021
(86) PCT No.: PCT/EP2021/084271

§ 371 Date: Jun. 3, 2024

(51) Int. Cl. C08G 77/08; C08G 77/00

(52) U.S. Cl. CPC C08G 77/08; C08G 77/70

(57) ABSTRACT

A process for preparing branched organopolysiloxanes includes organopolysiloxanes O that have a glass transition temperature (Tg) of 5° C. to 100° C. and contain units of the general formula (I), RₐSi(OR¹)_{b}O_{(4-a-b)/2} (I). Silanes of the general formula (II), RₙSi(OR¹)₄₋ₙ (II), are reacted with water, catalytic amounts of an acidic catalyst K, and optionally alcohol A. No other solvent apart from alcohol A is used throughout the entire process. Alcohol A is selected from methanol, ethanol or a mixture of methanol and ethanol. The organopolysiloxanes O have average molecular weights Mw in the range of 500 to 20,000 g/mol (weight average) with a polydispersity (PD) of at most 20.

The invention relates to a process for preparing branched organopolysiloxanes having a glass transition temperature (Tg) of above 0° C. from alkoxysilanes.

Processes for preparing solid organopolysiloxanes, also referred to as solid silicone resins, have long been prior art.

EP 0 927 734 B1 describes the multi-stage preparation of solid resins from alkoxysilanes catalyzed with hydrochloric acid in the presence of a water-immiscible solvent.

DE 10 2005 003 899 describes the preparation of resins, where chlorosilanes are reacted with alcohol and water in a single-stage continuous process. The preparation of solid resins requires the use of non-reactive solvents.

U.S. Pat. No. 6,552,151 B1 claims a solid resin with a Tg above 60° C. and a specific silanol content. The examples are prepared batchwise from ethoxysilanes, hydrochloric acid and water and worked up with an organic solvent.

The invention provides a process for preparing branched organopolysiloxanes O that have a glass transition temperature (Tg) of above 0° C. and contain units of the general formula (I):

RₐSi(OR¹)_{b}O_{(4-a-b)/2} Formula (I)
where
R is a hydrolysis-stable C1-C18 hydrocarbon radical that is unsubstituted or substituted by heteroatoms,
R¹ is a hydrogen radical or C1-C4 hydrocarbon radical and
a and b are 0, 1, 2 or 3, with the proviso that
a+b≤3 and
a in at least 70 mol %, preferably in at least 80 mol % and particularly preferably in at least 90 mol %, of all units of the general formula (I) has the value of 1,
a averaged over all units of the general formula (I) has an average value of 0.7 to 1.3, preferably of 0.8 to 1.2 and particularly preferably a value of 0.9 to 1.1,
b averaged over all units of the general formula (I) has an average value of 0.10 to 1.0, preferably of 0.15 to 0.9 and particularly preferably of 0.20 to 0.8,
and at least 70 mol %, preferably at least 80 mol % and particularly preferably at least 90 mol %, of all radicals R¹ are a hydrogen radical, methyl radical or ethyl radical,
in which silanes of the general formula (II)

RₙSi(OR¹)₄₋ₙ (II),
where
n can have the values of 0, 1, 2 or 3,
n in at least 70 mol % of the silanes of the general formula (II) has the value of 1,
R and R¹ have the definitions given for the general formula (II), in at most 20 mol % of the silanes of the general formula (II) all radicals R are a C1-C2 hydrocarbon radical and R¹ a methyl radical,
and per 100 mol of silanes of the general formula (II) there is at most 10 mol of further alkoxy- and/or hydroxy-functional organopolysiloxanes or alkoxy- and/or hydroxy-functional silanes,
are reacted with water, catalytic amounts of an acidic catalyst K, and optionally alcohol A,
with the proviso that no other solvent apart from alcohol A is used throughout the entire process,
where alcohol A is selected from methanol, ethanol or a mixture of methanol and ethanol, where up to 50 parts by weight of a further alkanol may be present in each case based on 100 parts by weight of methanol and ethanol.

In the process, the hydrolysis and condensation of the alkoxysilane of the general formula (II) is effected by way of a reaction with water, catalytic amounts of the acidic catalyst K, optionally alcohol A and optionally further alkoxy- and/or hydroxy-functional organopolysiloxanes or alkoxy- and/or hydroxy-functional silanes,
to give the end product, a branched organopolysiloxane having the desired degree of condensation. No other solvent apart from the alcohol A used and optionally a further alkanol is used throughout the entire process, with the exception of the customary denaturing agents in ethanol, at most 3% by weight, in particular at most 1% by weight, for example heptane and methyl ethyl ketone.

The process has in particular the following advantageous properties:
it permits preparation of viscous or solid organopolysiloxanes in an economically viable manner,
it permits reproducible preparation of organopolysiloxanes of constant composition from alkoxysilanes or mixtures of different alkoxysilanes,
it works entirely without the use of inert organic solvents, i.e. it contains only the organic components required as reactants in the reaction mixture,
it does not produce any wastewater phase,
it makes it possible to obtain products having very low residual acid contents,
it permits controlled setting of the alkoxy and hydroxy contents, and so it is suitable for providing both viscous and solid organopolysiloxanes in a robust procedure,
it has a recovery rate for the alcohol released of at least 95%.

No other solvents are needed in addition to alcohol A. Further solvents may be used, in particular those solvents having boiling points in the range of the alcohols used, as long as the reaction medium is homogeneous after addition of water; preference is given to specifically using no further solvents.

The acidic catalyst is deactivated after the reaction by suitable measures.

Thereafter, the branched organopolysiloxanes O can be worked up/purified by devolatilization. This frees it of volatile constituents and it is then present in its pure and thus final form. The devolatilization can be varied as desired, in which case the procedures are all within the scope of the known prior art and for example include distillation. Further examples of suitable variations are set out in more detail further below.

If alcohols are used, preference is given to those hydrocarbon compounds having an alcoholic hydroxyl group which can be used for the preparation of alkoxysilanes or for the preparation of organopolysiloxanes by reaction of chlorosilane with alcohols and optionally water. Preference is given to alkanols and ether oxygen-substituted alkanols each having 1 to 6 carbon atoms, such as methanol, ethanol, n- or isopropanol, 2-methoxyethanol, n-butanol or n-hexanol. Particular preference is given to methanol, ethanol, isopropanol and butanol, especially methanol and ethanol. It is also possible to use mixtures of different alcohols, which can optionally be homogenized in a short mixing section before feeding into the respective reaction unit. The ethanol may contain customary denaturing agents, such as methyl ethyl ketone, heptane, petroleum ether or cyclohexane.

Selected examples of hydrocarbon radicals R are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical, and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical, cycloalkyl radicals, such as cyclopentyl, cyclohexyl, cycloheptyl and methylcyclohexyl radicals, alkenyl radicals, such as the vinyl radical, aryl radicals, such as the phenyl, naphthyl, anthryl and phenanthryl radical, alkaryl radicals, such as tolyl radicals, xylyl radicals and ethylphenyl radicals, and aralkyl radicals, such as the benzyl radical and the β-phenylethyl radical. Particularly preferred hydrocarbon radicals R are the methyl, the vinyl, the n-propyl, the octyl radical and the phenyl radical.

The silanes of the general formula (II) may be used both as pure silanes and as a mixture of different silanes of the general formula (II).

Use may further be made of partial condensates as a solution in alcohol.

Preferably, n in at least 70 mol %, preferably in at least 80 mol % and particularly preferably in at least 90 mol %, of all units of the general formula (II) has the value of 1.

The organopolysiloxanes O preferably contain at least 90 mol %, particularly preferably at least 95 mol %, in particular at least 99 mol %, of units of the general formula (I).

Preferably, in at most 15 mol %, in particular at most 10 mol %, of the silanes of the general formula (II) all radicals R are a C1-C2 hydrocarbon radical and R¹ a methyl radical.

Preferably, per 100 mol of silanes of the general formula (II) there is at most 5 mol, particularly preferably at most 2 mol, in particular at most 1 mol of, very particularly preferably no, further alkoxy- and/or hydroxy-functional organopolysiloxanes or alkoxy- and/or hydroxy-functional silanes.

The water used is preferably partially demineralized water, fully demineralized water, distilled or (multiply) redistilled water and water for medical or pharmaceutical purposes, particularly preferably partially demineralized water and fully demineralized water.

The water used according to the invention preferably has a conductivity at 25° C. and 1010 hPa of at most 50 μS/cm. The water used according to the invention is preferably air-saturated, clear and colorless.

The acidic catalyst K used is preferably hydrochloric acid or compounds that form hydrochloric acid under reaction conditions, such as chlorosilanes, carbonyl chlorides or chlorides with elements of transition groups 3 to 8 or main groups 3 to 5.

Preferably 0.01 to 1 mol, in particular 0.01 to 0.5 mol, of HCl or compounds that form hydrochloric acid is used per 100 mol of R¹ in the silanes of the general formula (II).

Preferably 30 to 150 mol, in particular 40 to 100 mol, of water is used per 100 mol of R¹ in the silanes of the general formula (II).

The reaction preferably takes 10 min to 1 d, in particular 30 min to 6 h.

The process is preferably performed discontinuously, i.e. batchwise.

After completion of the reaction the acidic catalyst K is deactivated by suitable measures, such as the neutralization with alcoholic sodium hydroxide solution, sodium methoxide solution or sodium ethoxide solution, with alcoholic potassium hydroxide solution or the removal of the chloride atoms with a basic ion exchanger, such as, for example, weakly basic polystyrene resins, such as Purolite® A103Plus from Purolite or Amberlyst™ A21 from Dupont. Prior to the further work-up and any storage carried out, a residual hydrochloric acid content, titratable with ethanolic potassium hydroxide solution against tetrabromophenolphthalein ethyl ester, of 100 to 0 ppm is preferred, particularly preferably of 50 to 2 ppm, in particular of 30 to 5 ppm, in each case at 25° C.

The viscosity of the deactivated silicone resin solution is at most 100 mPa·s, particularly at most 80 mPa-s, in particular at most 50 mPa·s, in each case at 25° C.

Following the deactivation, the deactivated silicone resin solution can be worked up/purified by devolatilization. This frees it of volatile constituents and the organopolysiloxane O is then present in its pure and thus final form. The devolatilization can be varied as desired, in which case the procedures are all within the scope of the known prior art and for example include distillation. Further examples of suitable variations are set out in more detail further below.

The silicone resin solution can be purified by treatment with adsorbents, such as activated carbon, silica gels, crosslinked polystyrene resins or molecular sieves. The silicone resin solution is preferably treated with adsorbent prior to the work-up.

The organopolysiloxanes O preferably have average molecular weights Mw in the range of 500 to 20 000 g/mol (weight average) with a polydispersity (PD) of at most 20. Particularly preferably, they have an Mw of 600-15 000 g/mol with a polydispersity of 18; very particularly preferably, they have an Mw I of 700-10 000 g/mol with a polydispersity of 15; in particular, they have an Mw of 700-8000 g/mol with a polydispersity of 13. Since the organopolysiloxanes O may be either highly viscous or solid at room temperature, their melting temperatures can cover a wide temperature range.

The organopolysiloxanes O have a glass transition temperature (Tg) of preferably 5° C. to 100° C., particularly preferably 10° C. to 80° C., in particular 20° C. to 70° C.

The organopolysiloxanes O prepared by the process according to the invention or the preparations obtainable therefrom are well suited for use in anticorrosion preparations. In particular, they are suitable for use for the purpose of corrosion protection at high temperature.

Apart from for the purpose of high-temperature-resistant corrosion protection, the organopolysiloxanes O or the preparations obtainable therefrom can also be used for corrosion protection of reinforcement steel in reinforced concrete, in which case it is possible here to use the organopolysiloxanes O or the preparations obtainable therefrom either in pure form or in preparations. Corrosion-inhibiting effects in reinforced concrete are achieved here both when the organopolysiloxanes O or the preparations thereof that comprise them are introduced into the concrete mixture before it is shaped and cured, and by the direct application thereof to the surface of the concrete after the concrete has cured.

The organopolysiloxanes O or the preparations thereof can be used as binders for the production of artificial stones for indoor and outdoor use.

The organopolysiloxanes O or the preparations thereof can be used for the production of preimpregnated fibers, what are known as prepregs.

Apart from for the purpose of corrosion protection on metals, the organopolysiloxanes O can also be used for manipulation of further properties of preparations or of solid bodies or films obtainable therefrom:
controlling the electrical conductivity and the electrical resistance
controlling the leveling properties of a preparation
controlling the gloss of a moist or cured film or of an object
increasing weathering resistance
increasing chemical resistance
increasing hue stability
reducing the tendency to chalking
reducing or increasing the static and sliding friction on solid bodies or films
stabilizing or destabilizing foam in the preparation
improving the adhesion of the preparation
controlling the filler and pigment wetting and dispersing behavior,
controlling the rheological properties of the preparation,
controlling the mechanical properties, such as flexibility, scratch resistance, elasticity, extensibility, bending capacity, breaking behavior, resilience behavior, hardness, density, tear propagation resistance, compression set, behavior at different temperatures, expansion coefficient, abrasion resistance, and further properties, such as thermal conductivity, combustibility, gas permeability, stability to water vapor, hot air, chemicals, weathering and radiation, and sterilizability, of solid bodies or films
controlling the electrical properties, such as dielectric loss factor, dielectric strength, dielectric constant, tracking resistance, arc resistance, surface resistance, specific dielectric strength,
flexibility, scratch resistance, elasticity, extensibility, bending capacity, breaking behavior, resilience behavior, hardness, density, tear propagation resistance, compression set, behavior at different temperatures of solid bodies or films.

Examples of applications in which the organopolysiloxanes O can be used in order to manipulate the properties designated above are the production of coating materials and impregnations and of coatings and coverings obtainable therefrom on substrates, such as metal, glass, wood, mineral substrate, synthetic and natural fibers for the production of textiles, carpets, floor coverings, or other goods producible from fibers, or leather, plastics such as films, moldings. With appropriate selection of the preparation components, the organopolysiloxanes O may also be used in preparations as an additive for the purpose of defoaming, promoting leveling, hydrophobization, hydrophilization, filler and pigment dispersion, filler and pigment wetting, substrate wetting, promotion of surface smoothness, reduction of static and sliding resistance on the surface of the cured compound obtainable from the additized preparation. The organopolysiloxanes O may be incorporated into elastomer compositions in dissolved form, solid form or in cured solid form. In this case, they may be used for the purpose of strengthening or for improving other use properties, such as controlling the transparency, the heat resistance, the propensity to yellowing, the weathering resistance.

All the above symbols in the above formulae each have their definitions independently of one another. In all formulae, the silicon atom is tetravalent.

In the present text, substances are characterized by reporting of data that are obtained by instrumental analysis. The underlying measurements are either performed according to publicly accessible standards or determined by specially developed methods. In order to ensure the clarity of the teaching imparted, the methods used are specified here:

### Consistency:

The solid test substance is stored in chunks in a transparent glass bottle at 25° C. and standard pressure of 1013 mbar for 24 hours. The appearance and tackiness are then assessed.

### Solubility in Acetone:

1 g of test substance is admixed with 10 ml of acetone and the mixture is stirred for one hour at 25° C. and standard pressure of 1013 mbar. A visual assessment is then made as to whether the substance has completely dissolved.

### Molecular Compositions:

The molecular compositions are determined by means of nuclear magnetic resonance spectroscopy (for terminology see ASTM E 386: High-resolution nuclear magnetic resonance (NMR) spectroscopy: terms and symbols), with measurement of the 1H nucleus and 29Si nucleus.

Description of ¹H NMR measurement
Solvent: CDCl₃, 99.8% d
Sample concentration: approx. 50 mg/l ml CDCl₃ in 5 mm NMR tubes Measurement without addition of TMS, referencing of spectra with residual CHCl₃ in CDCl₃ at 7.24 ppm
Spectrometer: Bruker Avance I 500 or Bruker Avance HD 500
Probe: 5 mm BBO probe or SMART probe (Bruker)

### Measurement Parameters:

Pulprog=zg30
TD=64k
NS=64 or 128 (depending on probe sensitivity)
SW=20.6 ppm
AQ=3.17 s
D1=5 s
SFO1=500.13 MHz
O1=6.175 ppm

### Processing Parameters:

SI=32k
WDW=EM
LB=0.3 Hz

Depending on the type of spectrometer used, individual adjustments to the measurement parameters may be required.

### Description of ²⁹Si NMR Measurement

Solvent: C6D6 99.8% d/CCl4 1:1 v/v with 1% by weight of Cr(acac)₃ as relaxation reagent
Sample concentration: approx. 2 g/1.5 ml solvent in 10 mm NMR tubes
Spectrometer: Bruker Avance 300
Probe: 10 mm 1H/13C/15N/29Si glass-free QNP probe (Bruker)

### Measurement Parameters:

Pulprog=zgig60
TD=64k
NS=1024 (depending on probe sensitivity)
SW=200 ppm
AQ=2.75 s
D1=4 s
SFO1=300.13 MHz
O1=−50 ppm

### Processing Parameters:

SI=64k
WDW=EM
LB=0.3 Hz

Depending on the type of spectrometer used, individual adjustments to the measurement parameters may be required.

### Molecular Weight Distributions:

In the context of the present invention, the number-average molar masses Mn and the weight-average molar masses Mw are determined by means of size exclusion chromatography (SEC) in accordance with DIN 55672-1 against a polystyrene standard and detection with RI (refractive index detector) on a Styragel HR3-HR4-HR5-HR5 column set from Waters Corp. USA with an injection volume of 20 μl. The eluent used is toluene >99.9%, p.a., available from Merck KGaA, Darmstadt, Germany. The analyses are carried out at a column temperature of 45° C. The polydispersity (PD) is the quotient Mw/Mn.

### Glass Transition Temperatures:

The glass transition temperature Tg is determined by means of DSC (differential scanning calorimetry), using a Mettler-Toledo DSC1/500 dynamic scanning calorimeter (module name: DSC1_1448) in an open crucible and with a sample weight of 10.5 mg, under a constant nitrogen stream of 50 ml/min and with the following temperature regime:
temperature control at 25° C. for 5 minutes,
cooling to −150° C. at a cooling rate of 20 K/min,
temperature control at −150° C. for 8 minutes,
heating to 100° C. at a heating rate of 10 K/min,
temperature control at 100° C. for 15 minutes,
cooling to −150° C. at a cooling rate of 20 K/min,
temperature control at −150° C. for 8 minutes,
heating to 160° C. at a heating rate of 10 K/min,
cooling to −150° C. at a cooling rate of 20 K/min,
temperature control at −150° C. for 8 minutes,
heating to 160° C. at a heating rate of 10 K/min.

The glass transition temperature was determined during the 1st and 2nd heating to 160° C. using the STAR^{e} Software Version 16.20 from Mettler-Toledo, which defines the point of intersection of the measurement curve with the bisectors of the base lines before and after the glass transition as Tg; in the examples, the arithmetic mean of the two values is rounded to a whole number of degrees.

### EXAMPLES

The process according to the invention is described hereinafter in examples, however these should not be interpreted as being restricted thereto. All percentages are based, unless stated otherwise, on weight. Unless stated otherwise, all manipulations are performed at room temperature of about 25° C. and at standard pressure (1.013 bar). The apparatuses are commercially available laboratory equipment of the kind offered commercially by numerous equipment manufacturers.
Ph is a phenyl radical=C₆H₅—
Vin is a vinyl radical=CH₂═CH—
Me is a methyl radical=CH₃—. Me₂ accordingly is two methyl radicals.

### Example 1: Process According to the Invention

157 g of methyltriethoxysilane and 58 g of vinyltriethoxysilane are initially charged into a 1 l glass flask with reflux condenser, dropping funnel and magnetic stirrer, admixed with a mixture of 0.4 g of hydrochloric acid (20%) and 48 g of water over the course of 15 minutes and stirred at reflux for three hours.

The condensed, HCl-acidic organopolysiloxane solution thus formed is neutralized using a sodium methoxide solution (25% in methanol) to an HCl value of 15 ppm.

The alcoholic organopolysiloxane solution is then distilled and a cloudy solid is obtained, which dissolves completely in acetone and is defined by product parameters such as melting point, residual alkoxy content and molecular weight distribution. In a typical example, the following analytical data are obtained:

Molecular Composition from 29Si NMR:
MeSi(OH)O_{2/2}+MeSi(OEt)O_{2/2}: 23.0 mol %,
MeSiO_{3/2}: 52.6 mol %,
VinSi(OH)O_{2/2}+VinSi(OEt)O_{2/2}: 10.0 mol %,
VinSiO_{3/2}: 14.4 mol %,
   Composition from 1H NMR:
EtO_{1/2} content: 5.9% by weight,
HO_{1/2} content: 1.6% by weight
VinSiO_{3/2} content: 26.0% by weight,
MeSiO_{3/2} content: 66.5% by weight,

### Further Product Parameters:

| Consistency: | tack-free chunks | |
|---|---|---|
| Tg: | 40° | C. |
| Mw: | 840 | g/mol |
| Mn: | 300 | g/mol |

| | |
|---|---|
| PD: | 2.8 |

### Example 2: Process According to the Invention

The procedure from Example 1 is repeated, only with the difference that 54 g of water is used and for this reason stirring at reflux is performed for only one hour. A cloudy solid is obtained, which dissolves completely in acetone.

The following analytical data are obtained:

Molecular Composition from 29Si NMR:
MeSi(OH)O_{2/2}+MeSi(OEt)O_{2/2}: 23.8 mol %,
MeSiO_{3/2}: 51.9 mol %,
VinSi(OH)O_{2/2}+VinSi(OEt)O_{2/2}: 9.5 mol %,
VinSiO_{3/2}: 14.8 mol %,
   Composition from 1H NMR:
EtO_{1/2} content: 6.0% by weight,
HO_{1/2} content: 1.5% by weight
VinSiO_{3/2} content: 25.5% by weight,
MeSiO_{3/2} content: 67.0% by weight,

### Further Product Parameters:

| Consistency: | tack-free chunks, | |
|---|---|---|
| Tg: | 36° | C. |
| Mw: | 850 | g/mol |
| Mn: | 310 | g/mol |

| | |
|---|---|
| PD: | 2.7 |

### Example 3: Process According to the Invention

144 g of phenyltriethoxysilane, 75 g of methyltriethoxysilane and 11 g of methylvinyldimethoxysilane are initially charged into a 1 l glass flask with reflux condenser, dropping funnel and magnetic stirrer, admixed with a mixture of 0.4 g of hydrochloric acid (20%) and 52 g of water over the course of 15 minutes and stirred at reflux for three hours.

The condensed, HCl-acidic organopolysiloxane solution thus formed is neutralized using a sodium methoxide solution (25% in methanol) to an HCl value of 15 ppm. The alcoholic organopolysiloxane solution is then distilled and a clear solid is obtained, which dissolves completely in acetone and is defined by product parameters such as melting point or residual alkoxy content. In a typical example, the following analytical data are obtained:

Molecular Composition from 29Si NMR:
MeSi(OH)O_{2/2}+MeSi(OEt)O_{2/2}: 12.4 mol %,
MeSiO_{3/2}: 27.4 mol %,
PhSi(OH)O_{2/2}+PhSi(OEt)O_{2/2}: 32.7 mol %,
PhSiO_{3/2}: 20.7 mol %,
MeVinSiO_{2/2}: 6.8 mol %,
   Composition from 1H NMR:
EtO_{1/2} content: 3.0% by weight,
HO_{1/2} content: 1.0% by weight
PhSiO_{3/2} content: 67.0% by weight,
MeSiO_{3/2} content: 23.6% by weight,
MeVinSiO_{2/2} content: 5.4% by weight,

### Further Product Parameters:

| Consistency: | tack-free chunks |
|---|---|
| Tg: | 35° C. |

### Example 4: Process According to the Invention

218 g of phenyltrimethoxysilane is initially charged into a 1 l glass flask with reflux condenser, dropping funnel and magnetic stirrer, admixed with a mixture of 0.4 g of hydrochloric acid (20%) and 50 g of water over the course of 15 minutes and stirred at reflux for three hours.

The condensed, HCl-acidic organopolysiloxane solution thus formed is neutralized using a sodium methoxide solution (25% in methanol) to an HCl value of 15 ppm. The alcoholic organopolysiloxane solution is then distilled and a clear solid is obtained, which dissolves completely in acetone and is defined by product parameters such as melting point or residual alkoxy content. In a typical example, the following analytical data are obtained:

Molecular composition from 29Si NMR:
PhSi(OH)₂O_{1/2}+PhSi(OMe)(OH)O_{1/2}: 1.8 mol %,
PhSi(OH)O_{2/2}+PhSi(OMe)O_{2/2}: 60.0 mol %,
PhSiO_{3/2}: 38.2 mol %,
   Composition from 1H NMR:
MeO_{1/2} content: 1.7% by weight,
HO_{1/2} content: 2.0% by weight
PhSiO_{3/2} content: 96.3% by weight,

### Further Product Parameters:

| Consistency: | tack-free chunks |
|---|---|
| Tg: | 67° C. |

### Counterexample 1: Process not According to the Invention

120 g of methyltrimethoxysilane and 45 g of vinyltrimethoxysilane are initially charged into a 1 l glass flask with reflux condenser, dropping funnel and precision glass stirrer, admixed with a mixture of 0.25 g of hydrochloric acid (20%) and 40 g of water over the course of 15 minutes and stirred at reflux for two hours.

The condensed, HCl-acidic organopolysiloxane solution thus formed is neutralized using a sodium methoxide solution (25% in methanol) to an HCl value of 15 ppm. The alcoholic organopolysiloxane solution is then distilled and a solid is obtained, which does not dissolve completely in acetone.

1-8. (canceled)

9. A process for preparing branched organopolysiloxanes O that have a glass transition temperature (Tg) of 5° C. to 100° C. and contain units of the general formula (I):
RₐSi(OR¹)_{b}O_{(4-a-b)/2} Formula (I)
wherein
R is a hydrolysis-stable C1-C18 hydrocarbon radical that is unsubstituted or substituted by heteroatoms,
R¹ is a hydrogen radical or C1-C4 hydrocarbon radical and
a and b are 0, 1, 2 or 3, with the proviso that
a+b≤3 and
a in at least 70 mol % of all units of the general formula (I) has the value of 1,
a averaged over all units of the general formula (I) has an average value of 0.7 to 1.3,
b averaged over all units of the general formula (I) has an average value of 0.10 to 1.0,
and at least 70 mol % of all radicals R¹ are a hydrogen radical, methyl radical or ethyl radical,
in which silanes of the general formula (II)
RₙSi(OR¹)₄₋ₙ (II),
where
n can have the values of 0, 1, 2 or 3,
n in at least 70 mol % of the silanes of the general formula (II) has the value of 1,
R and R¹ have the definitions given for the general formula (I),
in at most 20 mol % of the silanes of the general formula (II) all radicals R are a C1-C2 hydrocarbon radical and R¹ a methyl radical,
and per 100 mol of silanes of the general formula (II) there is at most 10 mol of further alkoxy- and/or hydroxy-functional organopolysiloxanes or alkoxy- and/or hydroxy-functional silanes,
are reacted with water, catalytic amounts of an acidic catalyst K,
and optionally alcohol A,
with the proviso that no other solvent apart from alcohol A is used throughout the entire process,
where alcohol A is selected from methanol, ethanol or a mixture of methanol and ethanol, where up to 50 parts by weight of a further alkanol may be present in each case based on 100 parts by weight of methanol and ethanol
and that prior to the work-up of the organopolysiloxane solution the acidic catalyst is deactivated to a residual hydrochloric acid content, titratable with ethanolic potassium hydroxide solution against tetrabromophenolphthalein ethyl ester, of 100 to 0 ppm, where the organopolysiloxanes O have average molecular weights Mw in the range of 500 to 20,000 g/mol (weight average) with a polydispersity (PD) of at most 20.

10. The process as claimed in claim 9, in which the hydrocarbon radicals R are selected from methyl, vinyl, n-propyl, octyl and phenyl radicals.

11. The process as claimed in claim 9, in which n in at least 90 mol % of all units of the general formula (II) has the value of 1.

12. The process as claimed in claim 9, in which the acidic catalyst K used is hydrochloric acid or compounds that form hydrochloric acid under reaction conditions.

13. The process as claimed in claim 9, in which the organopolysiloxanes O have a glass transition temperature (Tg) of 10° C. to 80° C.

14. The process as claimed in claim 9, which is performed discontinuously.

15. The process as claimed in claim 9, in which after completion of the reaction the acidic catalyst K is neutralized with alcoholic sodium hydroxide solution, sodium methoxide solution, sodium ethoxide solution or potassium hydroxide solution.

16. The process as claimed in claim 9, in which after completion of the reaction the acidic catalyst K is neutralized with a basic ion exchanger.
